(19) United States
(12) Patent Application Publication
(10) Pub. No.: US 2008/0061662 A1
(43) Pub. Date: Mar. 13, 2008

(54) Computer table having U.S.B. interface socket, card reader and keyboard lamp

(76) Inventor: Ming-Chuan Lin, Taichung City (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 11/520,246

(22) Filed: Sep. 13, 2006

(51) Int. Cl. A47B 81/00; G06F 1/16

(52) U.S. Cl. 312/223.3; 361/683

(57) ABSTRACT

A computer table includes a table body, a keyboard support located under the table body, a socket mounted on the table body and having U.S.B. interface slots and integrated card readers, and a keyboard lamp mounted on the table body and directed toward the keyboard support. Thus, the computer main post is connected to a peripheral equipment by the U.S.B. interface slots and the integrated card readers of the socket without having to provide an extension cord or expansion socket additionally, thereby facilitating a user connecting the computer main post with the peripheral equipment. In addition, the keyboard lamp emits light beams toward the keyboard placed on the keyboard support during operation of the computer main post so as to provide an illuminating effect to the keyboard.

### BACKGROUND OF THE INVENTION

1. Field of the Invention

The present invention relates to a computer table and, more particularly, to a computer table having multiple functions.

2. Description of the Related Art

A conventional computer comprises a main post having a plurality of U.S.B. (universal bus) slots connected to a peripheral equipment by a plurality of U.S.B. connecting cords. The peripheral equipment includes a keyboard, mouse, rocker lever, printer, scanner, storage device, modem and the like. However, the number of the U.S.B. slots of the computer is not large enough for that of the peripheral equipment, so that the user needs to provide a U.S.B. extension cord or U.S.B. expansion socket additionally, thereby causing inconvenience to the user. In addition, the computer is not provided with a lighting device to provide an illuminating effect to the keyboard.

### BRIEF SUMMARY OF THE INVENTION

The primary objective of the present invention is to provide a computer table having a U.S.B. (universal bus) interface socket, a card reader and a keyboard lamp.

Another objective of the present invention is to provide a computer table, wherein the computer main post is connected to a peripheral equipment by the U.S.B. interface slots and the integrated card readers of the socket without having to provide an extension cord or expansion socket additionally, thereby facilitating a user connecting the computer main post with the peripheral equipment.

A further objective of the present invention is to provide a computer table, wherein the keyboard lamp emits light beams toward the keyboard placed on the keyboard support during operation of the computer main post so as to provide an illuminating effect to the keyboard.

A further objective of the present invention is to provide a computer table, wherein the keyboard lamp is pivotable relative to the keyboard support to adjust an inclined angle between the keyboard lamp and the keyboard support so as to adjust the illuminating angle.

Further benefits and advantages of the present invention will become apparent after a careful reading of the detailed description with appropriate reference to the accompanying drawings.

### BRIEF DESCRIPTION OF THE SEVERAL VIEWS OF THE DRAWING(S)

FIG. 1 is a perspective view of a computer table in accordance with the preferred embodiment of the present invention.

FIG. 2 is a partially exploded perspective view of the computer table as shown in FIG. 1.

FIG. 3 is a locally perspective enlarged view of the computer table as shown in FIG. 1.

FIG. 4 is a partially side plan cross-sectional operational view of the computer table as shown in FIG. 1.

FIG. 5 is a locally enlarged plan view of the computer table as shown in FIG. 4.

### DETAILED DESCRIPTION OF THE INVENTION

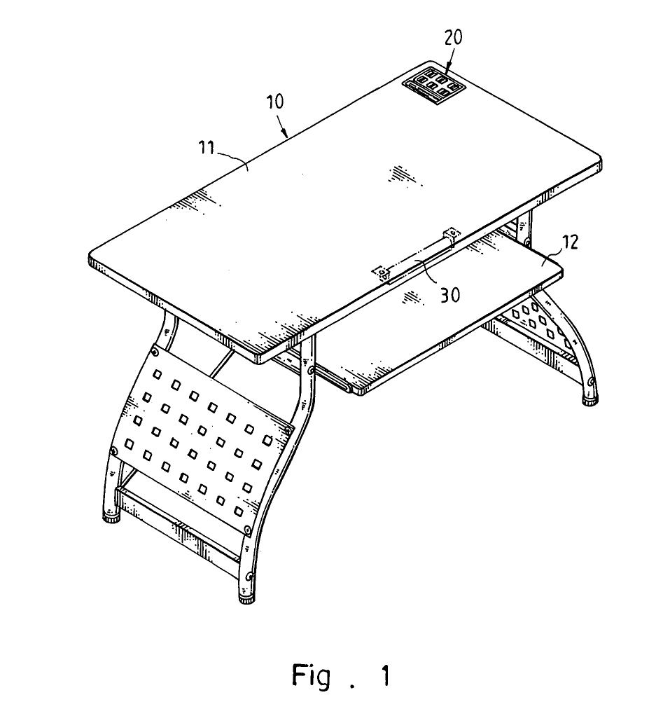

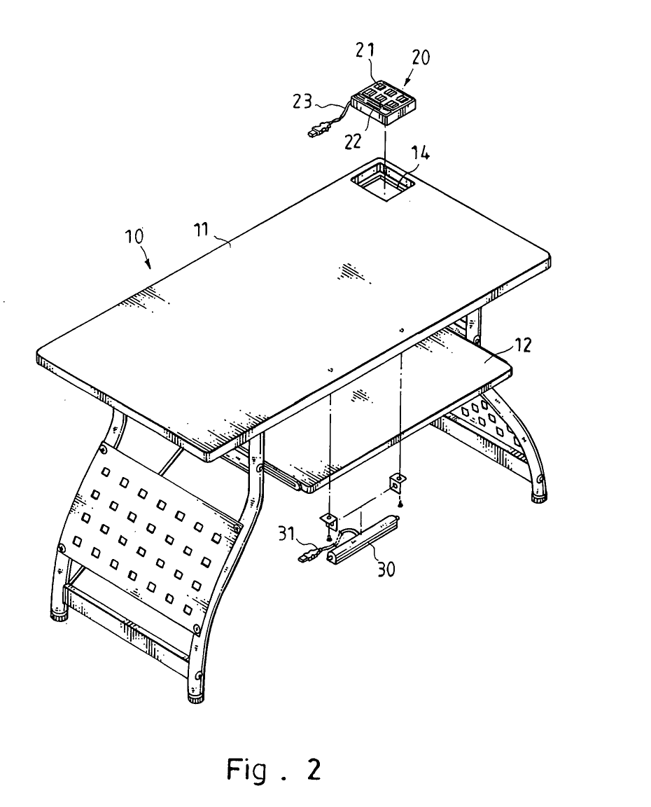

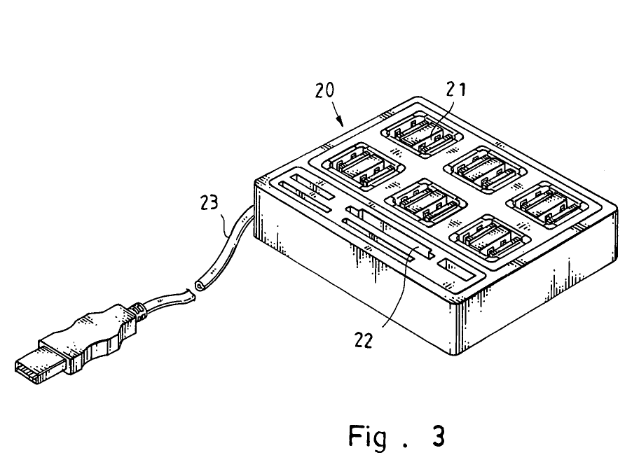

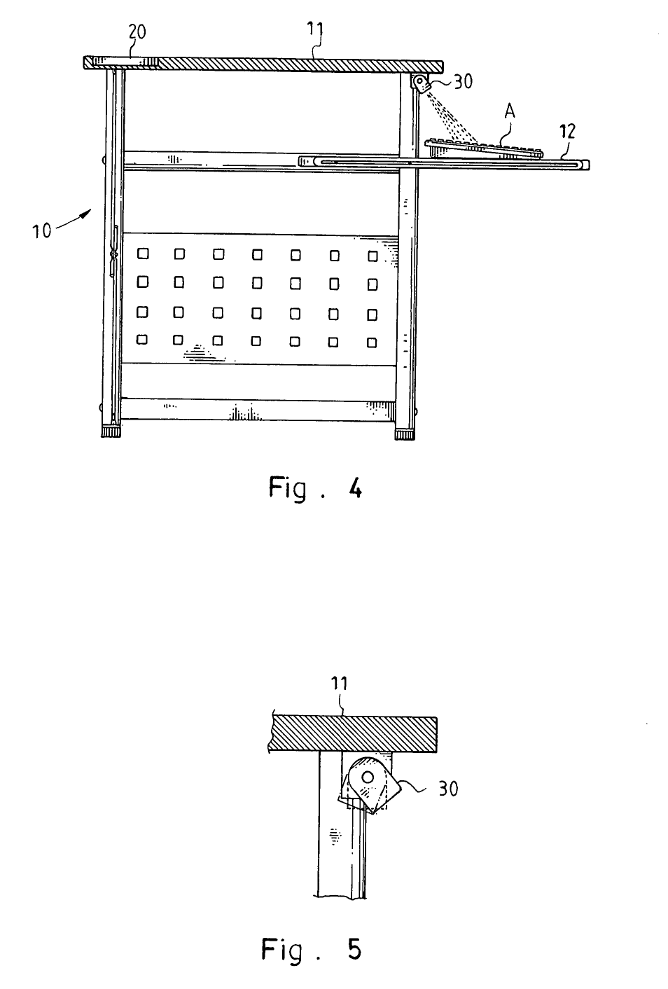

Referring to the drawings and initially to FIGS. 1-3, a computer table 10 in accordance with the preferred embodiment of the present invention comprises a table body 11, a keyboard support 12 located under and movable relative to the table body 11 to support a keyboard “A” (see FIG. 4), a socket 20 mounted on the table body 11 and having a plurality of U.S.B. (universal bus) interface slots 21 and a plurality of integrated card readers 22, and a keyboard lamp 30 mounted on the table body 11 and directed toward the keyboard support 12.

The socket 20 is mounted on a top face of a side of the table body 11 and has a side provided with a U.S.B. connecting cord 23 that is connected to a computer main post (not shown). The top face of the table body 11 is formed with a receiving chamber 14, and the socket 20 is fully hidden in the receiving chamber 14 of the table body 11.

The keyboard lamp 30 is pivotally mounted on a bottom of the table body 11 and located adjacent to a middle portion of a front edge of the table body 11. The keyboard lamp 30 is a light emitting diode (LED) and has a side provided with a U.S.B. connecting cord 31 that is connected to the computer main post.

In practice, the socket 20 of the computer table 10 is provided with a plurality of U.S.B. interface slots 21 and a plurality of integrated card readers 22 and is connected to the computer main post, so that the computer main post is connected to a peripheral equipment (not shown) by the U.S.B. interface slots 21 and the integrated card readers 22 of the socket 20 without having to provide an extension cord or expansion socket additionally, thereby facilitating a user connecting the computer main post with the peripheral equipment.

Referring to FIGS. 4 and 5 with reference to FIGS. 1-3, the keyboard lamp 30 is connected to the computer main post, so that the keyboard lamp 30 emits light beams toward the keyboard “A” placed on the keyboard support 12 during operation of the computer main post so as to provide an illuminating effect to the keyboard “A”. In addition, the keyboard lamp 30 is pivotable relative to the keyboard support 12 to adjust an inclined angle between the keyboard lamp 30 and the keyboard support 12.

Accordingly, the computer main post is connected to a peripheral equipment by the U.S.B. interface slots and the integrated card readers of the socket without having to provide an extension cord or expansion socket additionally, thereby facilitating a user connecting the computer main post with the peripheral equipment. In addition, the keyboard lamp emits light beams toward the keyboard placed on the keyboard support during operation of the computer main post so as to provide an illuminating effect to the keyboard. Further, the keyboard lamp is pivotable relative to the keyboard support to adjust an inclined angle between the keyboard lamp and the keyboard support so as to adjust the illuminating angle.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

1. A computer table, comprising:
a table body;
a keyboard support located under and movable relative to the table body;
a socket mounted on the table body and having a plurality of U.S.B. (universal bus) interface slots and a plurality of integrated card readers.

2. The computer table in accordance with claim 1, wherein the socket has a side provided with a U.S.B. connecting cord.

3. The computer table in accordance with claim 1, wherein the socket is mounted on a top face of a side of the table body.

4. The computer table in accordance with claim 3, wherein the top face of the table body is formed with a receiving chamber, and the socket is fully hidden in the receiving chamber of the table body.

5. The computer table in accordance with claim 1, further comprising a keyboard lamp mounted on the table body and directed toward the keyboard support.

6. The computer table in accordance with claim 5, wherein the keyboard lamp is pivotally mounted on a bottom of the table body.

7. The computer table in accordance with claim 5, wherein the keyboard lamp is located adjacent to a middle portion of a front edge of the table body.

8. The computer table in accordance with claim 5, wherein the keyboard lamp is a light emitting diode (LED).

9. The computer table in accordance with claim 5, wherein the keyboard lamp has a side provided with a U.S.B. connecting cord.

10. The computer table in accordance with claim 6, wherein the keyboard lamp is pivotable relative to the keyboard support to adjust an inclined angle between the keyboard lamp and the keyboard support.
